(19) United States
(12) Patent Application Publication
(10) Pub. No.: US 2025/0131448 A1
(43) Pub. Date: Apr. 24, 2025

(54) FRICTION METRIC FOR RESOLUTION OF CUSTOMER ISSUES

(71) Applicant: Wells Fargo Bank, N.A., San Francisco, CA (US)

(72) Inventors: Brittany Iwuagwu, Tampa, FL (US); Phani Kidambi, Lee, NH (US); David Price, Kennewick, WA (US)

(21) Appl. No.: 18/490,444

(22) Filed: Oct. 19, 2023

(51) Int. Cl. G06Q 30/016; G06Q 10/0639

(52) U.S. Cl. CPC G06Q 30/016; G06Q 10/06393

(57) ABSTRACT

A triangulated behavioral data system for assessing customer friction during interactions with a product or service. The system accesses three distinct behavioral data sources: (i) one capturing event-level data indicative of customer interactions; (ii) another documenting user session replays, providing intricate visualizations of user conduct; and (iii) a third supplying application performance metrics focused on system-level insights. By evaluating and merging data from these sources, which represent events, user behaviors, or performance indicators, a friction metric is computed. Weighted values are attributed to these factors based on their correlation to customer friction. The friction metric is updated to incorporate real-time customer behavior modifications. When the friction metric surpasses a predefined threshold or marker, a root cause analysis is launched, which aims to identify specific components causing the observed friction, paving the way for targeted improvements.

### BACKGROUND

In the expansive domain of business operations, the role of customer experience is paramount, directly influencing customer satisfaction, loyalty, and retention. Historically, tools and techniques have been employed to capture customer feedback and gauge their experience. These traditional methodologies, while beneficial, often fail to provide real-time insights and may lack a comprehensive understanding of customer friction points. Notably, reliance has been placed on customer feedback for monitoring customer experiences. However, such feedback is typically delayed and predominantly originates from a vocal minority, which may represent issues faced by only a small segment of users.

### SUMMARY

Embodiments of the disclosure are directed to a method for comprehensively assessing and quantifying customer friction encountered during interactions with an online product or service. In one embodiment, the method leverages a triangulated behavioral data system by accessing three distinct data sources: a primary source capturing event-level data signifying customer interactions, a secondary source that records user session replays, and a tertiary source emphasizing system-level insights through application performance monitoring. From the data, a friction metric is derived, combining the various events, user behaviors, and performance indicators, while updating in real-time as the customer engages with the product or service. When the friction metric crosses a predetermined threshold, a root cause analysis is launched, targeting the identification of elements contributing to observed customer friction.

In another aspect, a computer system, which includes one or more processors and non-transitory computer readable storage media, embodies the aforementioned method operations. Specifically, the system accesses the three behavioral data sources, computes the friction metric, and instigates the root cause analysis. The operations of the system provide real-time insights, ensuring swift responses to elevated customer friction levels.

Further, a computer program product, encoded on a non-transitory computer readable storage medium, facilitates these operations for friction assessment. Receiving data from the triangulated behavioral data sources, generating the friction metric by integrating and weighing the data points, and initiating the root cause analysis when friction is perceived beyond the set limits are all operational steps encapsulated in the program.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example a behavioral data system for assessing customer friction during interactions with a product or service.

FIG. 2 shows a system architecture diagram for a behavioral data framework to assess and quantify customer friction during interactions with an online product or service using the system of FIG. 1.

FIG. 3 shows a system architecture diagram for computing, analyzing, validating and reporting a customer friction metric during interactions with a product or service, as well as using validated customer friction metrics to train a machine learning algorithm.

FIG. 4 shows a detailed system architecture diagram of an individual neuron of the system architecture diagram of FIG. 3.

FIG. 5 shows example physical components of a behavioral data analytics device of the system of FIG. 1.

### DETAILED DESCRIPTION

In the dynamic world of business operations, customer experience holds immense importance, influencing satisfaction, loyalty, and retention. Traditionally, businesses used tools to gather customer feedback, but these methods often lack real-time insights and a comprehensive understanding of customer issues. For instance, in banking, systems aim to address specific customer challenges but rely on delayed feedback from a relatively small number of customers. Current systems, despite technological advances, have limitations, including delayed insights from customer reviews and challenges in linking issues to individual customers or understanding varied perspectives in the overall customer experience.

The present disclosure overcomes these limitations by introducing a holistic triangulated behavioral data approach to evaluate and measure customer friction in interactions with a product or service. This approach harnesses diverse behavioral data sources to compute a friction metric (alternatively termed a “friction score,” “friction index,” “satisfaction score,” or the like), serving as an early alert system to streamline issue resolution across organizational teams. The present disclosure identifies customer friction through observations, including metrics such as the time customers spend on specific actions, their usage patterns of particular apps or features, and other behavioral indicators.

The present disclosure details assessing and quantifying customer friction during interactions with a product or service using a triangulated behavioral data system. The process can, in some examples, involve accessing three distinct behavioral data sources: the first captures event-level data marking customer interactions within the product or service, the second records user session replays, providing a detailed view of user behavior, and the third offers application performance monitoring with a focus on system-level insights. A friction metric is then calculated by analyzing and consolidating data from these sources, assigning weighted values based on their correlation with increased customer friction, and continually updating the metric to reflect real-time changes in customer behavior.

In some embodiments, the system may employ artificial intelligence or machine learning to analyze the distinct behavioral data sources and compute the friction metric. When the friction metric exceeds predefined thresholds, a root cause analysis is initiated to identify specific elements causing customer friction and enable targeted improvements.

In some embodiments, a comprehensive report may be generated as an outcome of the root cause analysis when heightened friction is detected. This report can encompass various aspects, such as error or issue details, the devices utilized for product or service access, customer identities or characteristics, and other pertinent transaction information. This report can then be transmitted to a response team for thorough review and follow up action. Notably, the root cause analysis employed in generating the report can utilize artificial intelligence or machine learning systems to analyze the friction metric and related data to produce the report.

Furthermore, in some embodiments, the validity of the derived friction metric can be substantiated through various methods. These methods encompass comparing the derived friction metric with customer survey and feedback data, establishing correlations with customer satisfaction scores, and conducting a comparative evaluation with incident management protocols, which may include assessments of monitored telephonic activity and social media interactions.

The friction metric introduced by this disclosure serves as a valuable early warning system for various teams within an organization, including product teams and analytics teams. Applications of the behavioral data system and method are wide-ranging, for example: the system can aid in resource allocation, allowing teams to efficiently address increased customer inquiries and provide targeted support when the friction metric indicates elevated issues. Moreover, the system and method can offer better coordination among teams, fostering a proactive approach to issue resolution. Overall, the behavioral data system and method can provide comprehensive insights that enable businesses to improve the customer experience, ultimately enhancing customer satisfaction and fostering loyalty.

To achieve these objectives, the behavioral data system and method can utilize advanced techniques such as decision trees or machine learning algorithms for calculating the friction metric and conducting root cause analysis, ensuring a robust and data-driven approach to assessing customer friction. Additionally, a validity of the friction metric can be confirmed through various data sources and correlation methods, further bolstering its reliability as a tool for improving the customer experience. Moreover, the behavioral data systems and methods disclosed herein address issues related to computer technology, employing advanced data analysis techniques to provide a specific technical solution for identifying and mitigating customer friction.

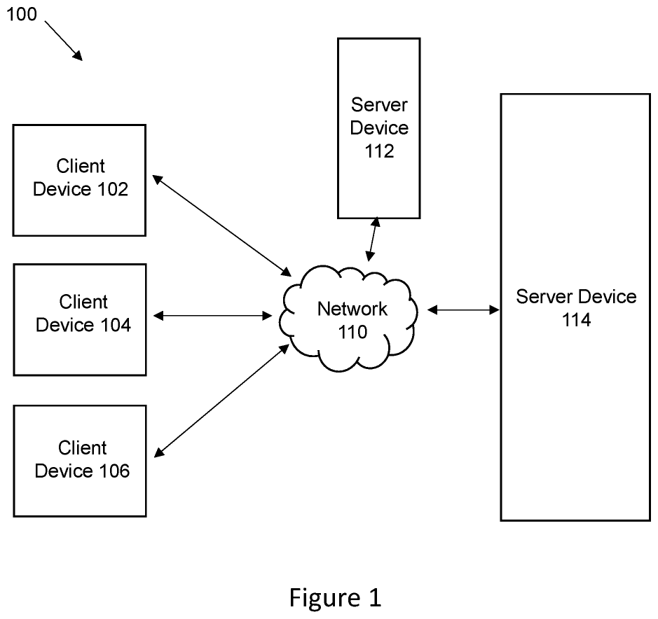

FIG. 1 provides a schematic representation of a system 100 designed for the assessment and quantification of customer friction during interactions with a product or service. Customer friction denotes the level of inconvenience or difficulty experienced by customers during their interactions with a product or service. A product or service can encompass any offering or solution provided to a customer. While certain embodiments emphasize the evaluation of customer friction within the context of financial and currency exchange-related transfer systems, the principles disclosed herein are adaptable to various business domains and operational frameworks.

As further provided in FIG. 1, system 100 embodies a computing environment comprising one or more client devices 102, 104, and 106. These client devices 102, 104, and 106 serve as endpoints within the system 100 and are connected to one or more server devices identified as 112 and 114 through a network 110. The client devices 102, 104, and 106, which may be utilized by both business personnel and customers for transactional purposes, are characterized as computing devices equipped with a minimum configuration of at least one central processing unit (CPU) or processor and associated memory storage.

Server 114 is presented as a representation of a server infrastructure, which may include a server farm or cloud-based architecture. In certain embodiments, the server 114 may be employed to store and manage performance data and related metrics associated with one or more online products or services.

Server 112 is presented as a representation of a behavioral data analytics device. In embodiments, server 112 is configured to facilitate communication between the client devices 102, 104, and 106 and server 114. This communication encompasses interactions between the client devices 102, 104, and 106 and server 114 for the purpose of assessing and quantifying customer friction.

In some embodiments, server 112 is configured to implement a method for the assessment and quantification of customer friction during interactions with a product or service. Within this function, server 112 is equipped to access distinct behavioral data sources, which include: (i) a first source responsible for capturing event-level data that marks customer interactions within the product or service; (ii) a second source designed for recording user session replays, providing a detailed visualization of user behavior; and (iii) a third source formulated to deliver application performance monitoring, with a focus on system-level insights. In some embodiments, the behavioral data associated with these sources may be stored by server 114, one or more of the client devices 102, 104, 106, or a combination of both server 114 and one or more client devices.

Subsequently, server 112 is configured to perform an analysis of the data obtained from the distinct behavioral data sources to compute a consumer friction metric. If this consumer friction metric surpasses a predefined threshold, server 112 is programmed to activate an analysis module to assist in identifying the root cause responsible for the increase in consumer friction. Furthermore, in some embodiments, server 112 is configured to employ one or more validation data sources (which may be maintained by server 114 or one or more of the client devices 102, 104, 106) as part of a process to crosscheck a validity of an outcome derived from the analysis of the consumer friction metric.

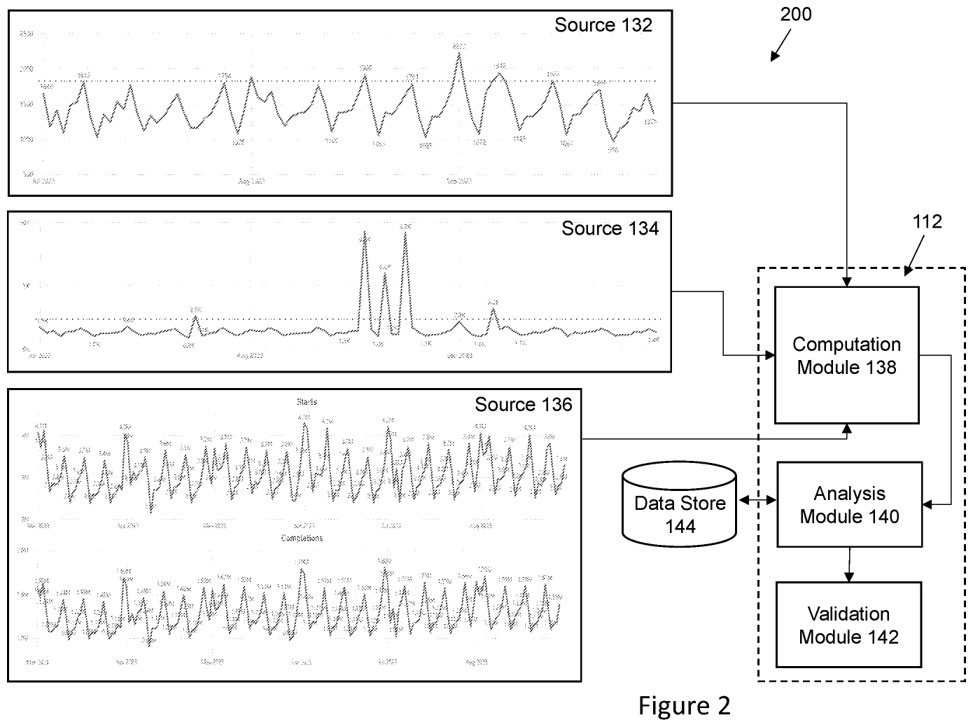

Referring to FIG. 2, a system architecture diagram 200 of the system 100 is depicted to assess and quantify customer friction during interactions with an online product or service. In some embodiments, the system 100 establishes communication links with multiple data sources. These data sources are repositories or channels which furnish data, information, metrics, or other indicators that pertain to the performance, usage patterns, and overall interaction of customers with an online product or service.

Specifically, the depicted system architecture 200 of system 100 integrates three distinct data sources, including a first data source 132 (Source I), a second data source 134 (Source II), and a third data source 136 (Source III). Each of these data sources 132, 134, 136, is unique in its capacity, type, and nature of data it provides, contributing to the comprehensive analysis and quantification of customer friction within a specified online product or service environment.

The first data source 132 can be characterized by its event-level granularity which captures and records specific actions, behaviors, and sequences of interactions initiated by customers while engaging with the product or service. The first data source 132 is designed to systematically capture, document, and store discrete actions, behaviors, and a series of interactions conducted by users. Such interactions occur when users interface with a specified digital product or service. The term “granularity” in this context refers to the detailed precision with which data points or events are captured, allowing for high-resolution insights. As a result, the first data source 132 offers an in-depth perspective into user activities, enumerating each distinct event or action executed by the user during their engagement with the aforementioned digital product or service.

In FIG. 2, the illustration showcases the processing and presentation of data originating from the first data source 132. Specifically, the graphical representation displays a singular output value or composited metric, subjected to temporal variations. The purpose of this representation is to illustrate the frequency or incidence of successful task completions facilitated by an online platform dedicated to a specific product or service, for example, instances of unsuccessful transfers or payments. In this particular example, the transactions initiated by a customer, aiming to facilitate a monetary transfer or payment directed towards a third-party vendor. An observable trend in the data indicates a spike in the frequency of these unsuccessful transactions approximately around the periods commonly recognized as paydays, suggesting that during periods where a larger volume of transactions are anticipated, a surge in unsuccessful attempts emerges.

Also present within the graphical representation is a delineated line, depicted in a dotted format. This line serves a dual purpose: Firstly, it demarcates a metric of notable significance, specifically pointing towards a success rate of 99%. This translates to a scenario wherein 99 out of every 100 attempts to facilitate a transfer or payment are successfully executed. Secondly, this delineated line acts as a threshold or benchmark. If, at any point in time, the data, specifically the unsuccessful transaction attempts, surpass this line, it suggests that a notable fraction, exceeding 1% of the customer base, faces challenges in completing their intended transactions, which may imply potential complications, discrepancies, or malfunctions within the product or service. While a plethora of reasons can contribute to these unsuccessful transactions ranging from user errors to system glitches, a breach of this threshold predominantly implies a pressing need to investigate potential issues, rectify any detectable anomalies, and further optimize the system to ensure seamless user experience.

The second data source 134, can be a mechanism or tool specifically designed to facilitate the recording of user session replays, as well as the tagging of certain events during a user interaction. In some embodiments, the second data source 134 can be integrated with third-party services, such as Glassbox, or the like. Through these recorded sessions, the second data source 134 can provide an in-depth, sequential visualization of user interactions and activities as they engage with the online product or service. By capturing and reproducing these interactions, the second data source 134 aims to present a comprehensive understanding of customer behavior, facilitating the identification of patterns, anomalies, or specific points of interaction during their session.

For example, in embodiments, the second data source 134 can be configured to: (i) permit the replay of user sessions, aiding in the identification of usability discrepancies, errors, and improvement areas within a digital interface; (ii) display graphical representations of user interactions, indicating areas of mouse clicks, cursor movement, or page scrolling; (iii) assist in determining user discontinuation points within digital processes, e.g., checkouts or sign-ups; (iv) enable real-time error detection and logging within the interface; (v) identify potential form interaction issues, typical in registration or checkout processes; (vi) monitor the operational efficiency and loading times of webpages and applications; and (vii) ensure data privacy by masking or excluding sensitive user data in accordance with regulatory standards.

In FIG. 2, the illustration showcases the processing and presentation of data originating from the second data source 134. Similar to the graphical representation of data from the first data source 132, the graphical representation of the second data source 134 reveals a discernible pattern that becomes pronounced during intervals generally identified as paydays. In the aforementioned graphical portrayal, one can discern a dotted line serving dual functionalities: Firstly, it demarcates a parameter of substantial relevance. This parameter is indicative of a success rate positioned at 99%. In practical terms, this suggests that for every set of 100 transaction attempts, 99 are finalized within the duration generally expected for such transactions, a duration determined based on consumer averages. Secondly, this delineated line acts as a reference point or a benchmark. Should the data, specifically denoting transactions not be concluded in the typical duration, exceed this line at any chronological juncture, it insinuates that a significant segment, surpassing 1% of the overall user population, confronts difficulties in effectuating their intended transactions within the standard timeframe.

A breach of this threshold is indicative of potential challenges that may span from irregularities, discrepancies, to potential dysfunctions inherent within the product or service mechanism, which are distinct from those associated with the first data source 132. While the first data source 132 emphasizes unsuccessful transaction completions, the implications arising from the second data source 134 primarily revolve around elongated transaction durations, not necessarily culminating in transaction failures. The distinction rests in the elongation of the process time rather than the outright non-completion of a transaction.

The third data source 136 can encompass a mechanism for monitoring the performance of software applications. For example, the third data source 136 can be configured to provide a systematic evaluation, emphasizing metrics and observables at the system infrastructure level. Within its operational capacities, third data source 136 possesses the capability to continuously scrutinize and verify the operational integrity of Application Programming Interfaces (APIs). The term “Application Programming Interfaces (APIs)” in this context signifies a set of protocols and tools that permit different software applications to communicate and interact with each other. These APIs act as integral components within an online product or service framework, ensuring seamless functionality and interoperability of disparate system modules.

Referring to FIG. 2, the diagram 200 provides a detailed representation of the processing and subsequent presentation of data derived from the third data source 136. This data specifically pertains to the cumulative count of initiation events (or “starts”) and culmination events (or “completions”) corresponding to one or multiple Application Programming Interfaces (APIs) that play a role in the customer's digital interaction with the said product or service.

In the normal operational course of an online interface, the number of API initiation events might not precisely align with the number of culmination events. Such disparities can emanate from a myriad of reasons, ranging from user-initiated discontinuations to minor technical glitches. However, a substantial divergence between the count of initiation events and culmination events, as recorded from the third data source 136, can be indicative of underlying challenges. When the deviation surpasses routine operational variances, it can serve as an indicator, signaling potential systemic issues or functional anomalies associated with the product or service.

With continued reference to FIG. 2, a computation module 138, which can be a component of server 112, can be configured to aggregate and process data extracted from the first, second, and third data sources 132, 134, and 136 respectively, with the primary purpose of deriving a metric termed as a “friction metric.” In the calculation of a friction metric, each individual data point harvested from the three data sources plays a contributory role in a weighted scoring framework. In this framework, distinct events, user interaction patterns, and performance metrics are allocated specific weights. The allocation is done in alignment with the degree of their relevance and impact concerning the customer friction experienced during interactions with the product or service. In embodiments, these weights are not necessarily static and may be founded upon predetermined criteria that help to quantify their role in inducing customer friction.

In some embodiments, the system 100 is designed to refresh and recalibrate the friction metric periodically. This iterative updating ensures that the friction metric mirrors real-time shifts and nuances in customer interaction dynamics. This computational approach is aimed at synchronizing with all relevant feedback mechanisms, thereby facilitating the generation of a timely and contextually accurate friction metric for specific features or transactions. Accordingly, as end-users engage with the product or service in their customary patterns, the system remains vigilant, processing the behavioral data streams in real-time to generate an updated friction metric.

As further depicted in FIG. 2, an analysis module 140 can be configured to evaluate the friction metric, and juxtapose it against predetermined thresholds that have been established as benchmarks. When the computed friction metric breaches these thresholds, the analysis module 140 triggers an integrated early warning mechanism. The activation of this mechanism serves to identify and highlight potential areas wherein customers might be predisposed to face obstacles or sense dissatisfaction during their interactions with the product or service.

For example, the analysis module 140 can be equipped with the capability to interface with a data repository, denoted as data store 144. The contents of this data store 144 can encompass various analytical assets, which include, but are not restricted to, reference lookup tables, decision tree algorithms, and an assortment of other analytical tools and instruments to facilitate the analysis module 140 in its diagnostic assessment of the friction metric. Specifically, the analytical tools can aid in the accurate identification of root causes or underlying issues that might compromise the efficacy or user satisfaction of a product or service.

An inherent functionality within the system 100 ensures the compilation and transmission of a detailed diagnostic report. The contents of this report can be crafted to provide an exhaustive insight into the events leading to the threshold breach. For example, the report can identify likelihoods associated with errors or discrepancies that led to the breach of the established thresholds. The report can provide a detailed inventory of the diverse device types that were employed by users to access the product or service at the time the identified issue manifested. The report can classify the customer demographic that bore the brunt of the issue, offering insights into affected segments. Additionally, the report can collate pertinent transaction-related data, with an emphasis on highlighting patterns or consistencies among the interactions that were adversely impacted. In some embodiments, upon compilation, the report can be relayed to relevant stakeholders or teams within an organization, empowering the stakeholders with the requisite data to initiate corrective and preventive measures.

As discussed in subsequent sections, either or both of the computation module 138 and the analysis module 140 can incorporate machine learning (ML) algorithms to facilitate the computation and subsequent evaluation of the friction metric. The term “machine learning” as referenced herein, pertains to a subset of artificial intelligence (AI) where systems are trained to learn from data, thereby enabling them to make decisions without being explicitly programmed for specific tasks. Through the application of these ML techniques, the computation module 138 and the analysis module 140 can enhance the accuracy and reliability of the friction metric calculations and associated analyses.

Additionally, both the computation module 138 and analysis module 140 can possess the capability to interface with the trio of data sources, namely the first data source 132, the second data source 134, and the third data source 136. By querying these data sources, the modules can assimilate supplementary data. This additional data acquisition facilitates a more granular and enriched representation of the issues users may perceive while interacting with the online product or service, thereby enhancing the fidelity of the assessment and subsequent recommendations or actions.

The system further incorporates a validation module 142, which is configured to assess and ascertain the accuracy and reliability of the friction metric, positioning it as an instrument for preemptive enhancements in customer experience. For the purposes of validation, the validation module 142 may employ a variety of methods. One such method involves juxtaposing the friction metric against Voice of the Customer (VOC) data. “Voice of the Customer” or VOC pertains to an aggregate of direct feedback, testimonials, and other forms of communication gathered from end-users or customers regarding their experiences, preferences, and expectations.

Beyond VOC data, the validation module 142 can also benchmark the friction metric against Customer Satisfaction (CSAT) scores. “Customer Satisfaction” scores, commonly abbreviated as CSAT, encapsulate a metric that quantifies the overall contentment or satisfaction levels of customers based on their interactions with a product or service.

Furthermore, the validation module 142 can draw upon Incident Management Protocols as an ancillary avenue to evaluate the veracity of the friction metric. Incident management protocols can include a structured model which monitors customer activities across telephonic communication channels, employs a system to detect reported outages of an online product or service, or scrutinizes chatter or discussions on various social media platforms, which may arise in the wake of service incidents or disruptions.

Concluding the validation process, the system undertakes a correlation analysis. This analytical process discerns and interprets the relationship between the friction metric and the aforementioned validation data sources, specifically VOC data, CSAT scores, and Incident Management Protocols. One objective of this correlation analysis is to identify patterns or instances wherein escalated friction metrics conspicuously coincide with adverse customer feedback or experiences, to confirm the presence of an issue with the product or service.

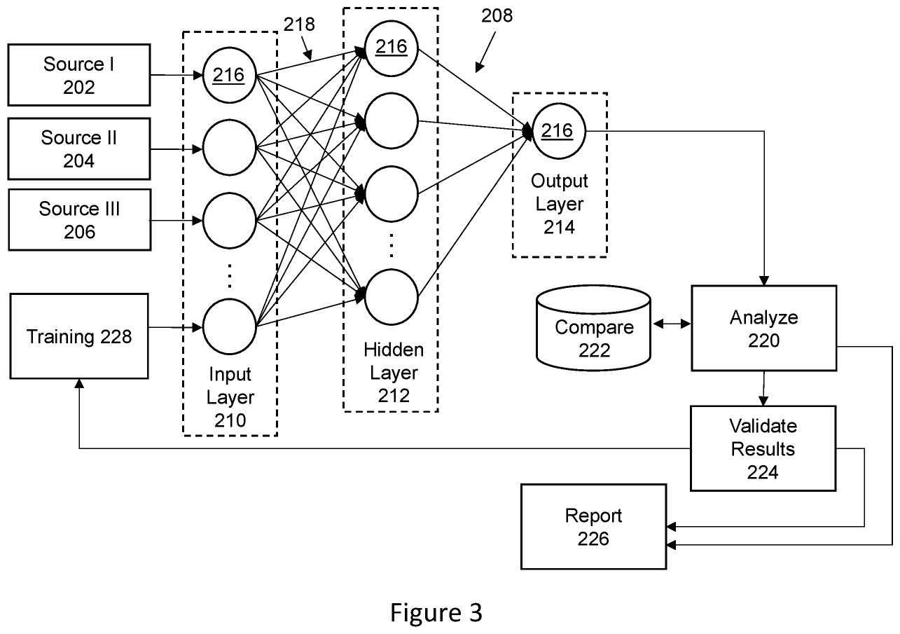

Referring to FIG. 3, a system architecture 200 for assessing customer friction during interactions with an online product or service is depicted in accordance with an embodiment of the disclosure.

At reference number 202A-C, data from the respective first, second and third data sources 132, 134, and 136 are communicated to the computation module 138. Various mechanisms can be employed to facilitate the transfer of data from these data sources to the computation module 138. One such method involves the computation module 138 initiating queries to the data sources 132, 134, and 136. For example, in one embodiment, the computation module 138, through internal command sequences, can send out specific requests to each data source. These requests are formulated to fetch pertinent data based on predefined parameters or filters. The computation module 138 may encompass an integrated API, or other set of tools, definitions, and protocols that facilitates the creation and interaction of software applications to aid this data retrieval process. This integrated API in the computation module 138 can establish a standardized channel of communication, allowing it to request, receive, and process data from the data sources 132, 134, and 136 in a streamlined manner.

Alternatively, the data sources 132, 134, and 136 themselves may have configurations in place to “push” relevant data to the computation module 138 at regular intervals or when certain conditions are met. In some embodiments, specific events or triggers, once detected within the data sources 132, 134, and 136, can initiate the transfer of relevant datasets to the computation module 138. In some embodiments, data can be accumulated over a predefined time period or until it reaches a certain volume in the data sources 132, 134, and 136, after which it is sent to the computation module 138 in batches for processing.

In some embodiments, the computation module 138 is equipped with a set of instructions or an algorithm. This algorithm can possess the capability to be dynamically modulated or adjusted, facilitating the identification and revelation of inherent patterns or structures latent within the input data. Such types of algorithms, which autonomously analyze data without explicit prior labeling or classification, are classically categorized under the domain of “unsupervised learning algorithms.” For clarity, unsupervised learning algorithms operate without pre-existing labels and attempt to categorize or cluster the data based on inherent patterns or structures discerned within the data itself. For example, in one embodiment, the algorithm can be formulated and executed utilizing a platform commonly identified as “TensorFlow,” a prominent open-source machine learning framework, facilitating the creation, training, and deployment of deep learning models.

With continued reference to FIG. 3, in some embodiments algorithm 208 can encompass a neural network, which can include various components, including, but not limited to, an input layer 210, at least one hidden layer 212, and an output layer 214, with each layer 210, 212, and 214, including at least one neuron 216. The depicted embodiment shows only a single hidden layer 212; however, other embodiments may incorporate multiple hidden layers 212, depending on the complexity and requirements of the algorithm.

The data that serves as an input to the input layer 210 originates from performance metrics as encapsulated within data sources 132, 134, and 136. In one embodiment, the neuron count within the input layer 210 can equate to the number of data sources, i.e., 132, 134, and 136, or the individual metrics intended for assessment. The data value for each neuron in the input layer 210 can be represented numerically.

The configuration of the neural network 208 ensures that each neuron 216 within a given layer, exemplified by the input layer 210, establishes a connection with every neuron 216 present in the succeeding layer, as exemplified by the hidden layer 212. Such connections are referred to as connection 218. Given this arrangement, the layers within the neural network 208 adopt a fully interconnected architecture.

While the above description outlines a fully connected neural network, it is also contemplated that the algorithm 208 may adopt the structure of a convolutional network. In such a configuration, specific clusters of neurons 216 within a layer might be linked to one or more discrete neurons 216 located in the following layer. Notably, these neuron groups within a layer would possess a shared weight value.

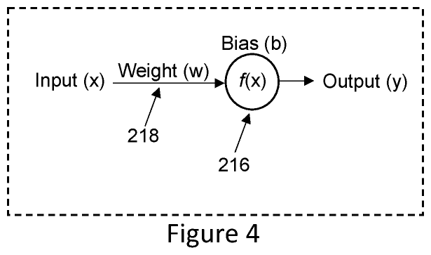

Turning now to FIG. 4, a more detailed examination of the neurons 216 of the system architecture of FIG. 3 is provided. Each of the neurons 216 is configured to accept one or multiple input variables, symbolized as x, and subsequently produce a resultant output variable, symbolized as y. In the context of networks exhibiting full connectivity, every neuron 216 is allocated a distinct bias term, denoted as b. Simultaneously, each of the connections, labeled as 218, receives an assigned weight value, denoted as w. Adjustment of these weight values and bias terms, in unison, is integral to the learning capacity of the algorithm 208, as this adjustment enables the algorithm 208 to discern and identify underlying patterns within the dataset. Mathematically, the operational behavior of each neuron 216 can be depicted through a predefined function. This function denotes that the output (y) produced by a neuron 216 is inherently influenced by the cumulative input's connection weights and the neuron's own bias term. This relationship can be concisely represented by the equation: y=w×x+b.

In some embodiments, the resultant output (y) emerging from the neuron 216 possesses the capability to assume any designated value, for example a numerical value within the range of 0 to 1. Additionally, the computation of the resultant output can be governed by various mathematical functions. This includes, but is not limited to, linear functions, sigmoid functions, hyperbolic tangent (tanh) functions, and rectified linear units. Certain functions, especially those that effectively counteract saturation (that is, sidestep exceedingly high or low output values), play a role in ensuring the stability of the algorithm 208. Saturation in this context refers to scenarios where certain activation functions may compress their input into a very small output range in a very non-linear fashion, hindering the unsupervised learning process.

In some embodiments, the output layer 214 can include neurons 216 corresponding to a desired number of outputs of the neural network 208. For example, in one embodiment, the neural network 208 can include a single output neuron. The resultant output value derived from this neuron can be defined within the bounded range of 0 to 1, which can signify the calculated probability concerning the existence of a discernible issue with the digital product or service that can adversely impact customer interactions.

In another embodiment, an ensemble of output neurons can be structured to represent diverse probabilistic outcomes, including the likelihood of technical disruptions in the digital service, the estimated chance of user interface complexities, the probability of data security vulnerabilities, to the anticipated risk of performance bottlenecks, among others. Each unique output neuron, within such a design construct, can be dedicated to elucidating the probability metric associated with each distinct outcome or event in the online product or service spectrum.

The goal of the deep learning algorithm is to tune the weights and balances of the neural network 208 until the inputs to the input layer 210 are properly mapped to the desired outputs of the output layer 214, thereby enabling the algorithm 208 to accurately produce outputs (y) for previously unknown inputs (x). For example, with data gathered by the system 100 fed into the input layer 210, one desired output of the neural network 208 would be to indicate of probability of an issue presently occurring or prediction of an issue which may occur within an online product or service that can adversely impact customer interactions. In some embodiments, the neural network 208 can rely on a sampling of training or control data (e.g., inputs with known outputs) to properly tune the weights and balances.

The objective of the deep learning algorithm is to undergo iterative refinement and calibration of the associational parameters, specifically denoted as weights, and the adjustment entities, termed as biases, contained within the neural computational framework, or more formally referred to as the neural network 208. This process is directed towards ensuring that data inputs presented to the foundational computational segment, hereafter classified as the input layer 210, are meticulously correlated to the stipulated outcomes of the terminal computational segment, aptly labeled as the output layer 214. Through such a methodical calibration, the neural network 208 is furnished with the capability to generate accurate output values when introduced to novel input datasets that have not been previously encountered during its training phase.

Illustratively, when data collated by a designated operational system is channeled to the input layer 210, a specific outcome that the neural network 208 aims to deduce is a quantitative assessment. This quantification can signify the immediate likelihood of an identifiable discrepancy surfacing within a digital product or service platform or proffer a foresight into potential issues that may manifest in the foreseeable future. Any such anomaly holds the potential to detrimentally influence the quality of user interactions.

In some embodiments, the operational modality of the neural network 208 can be predicated on a subset of instructive datasets, termed training or control data. Notably, this data subset can encompass input entities with predetermined and known output correlations. The intrinsic purpose of leveraging this data subset is to efficaciously calibrate the weights and biases to attain optimal algorithmic performance within the algorithm 208.

For the purpose of calibrating the designated neural computational algorithm 208, a defined metric termed as the cost function is employed. The cost function aids in ascertaining the proximity between the real-time output values deduced by the output layer 214 and the benchmark output values stipulated within the training dataset. Numerous functional forms, including but not limited to quadratic cost function and cross entropy cost function, can serve as this designated metric.

Each singular iteration, wherein the neural network 208 processes the entirety of the training dataset, is formally recognized as one epoch. Over an extended succession of these epochs, a deliberate refinement is undertaken on the associational parameters (weights) and adjustment entities (biases) embedded within the neural network 208. The central aim of this iterative calibration is to progressively diminish the value of the cost function. An optimal calibration of the neural network 208 is achieved by computing the gradient descent of the cost function. This computational operation seeks to identify a global minimum within the cost function landscape, representing the least cost or error. Certain embodiments might employ a specific computational procedure, referred to as the backpropagation algorithm, for deducing the gradient descent of the cost function.

The backpropagation algorithm calculates the partial derivatives of the cost function in relation to every singular weight and bias present within the algorithmic construct of the neural network 208. Thus, this algorithm facilitates the continuous monitoring of minuscule adjustments made to the weights and biases as they navigate through the various layers of the network, culminate at the output layer, and subsequently influence the cost metric.

Certain embodiments may incorporate a constraint, termed as the learning rate, during the calibration process to forestall overfitting within the neural network 208. Overfitting arises when modifications to weights and biases are disproportionately extensive, leading to the cost function surpassing its global minimum. For illustrative purposes, certain embodiments might fixate the learning rate within a range spanning approximately 0.03 to approximately 10. Additionally, for the purpose of assisting in the diminution of the cost function, several embodiments might adopt distinct regularization methodologies. Methods such as L1 and L2 regularization can be selectively implemented to achieve this goal.

At reference numeral 220, the resultant value produced by algorithm 208, herein denoted as the “friction metric.” undergoes analysis. The system is configured to review the derived friction metric and conduct a comparative analysis against preset boundary values, which are demarcated as standards or benchmarks. In scenarios wherein the evaluated friction metric surpasses or is deficient compared to these established boundary values, the analysis module 140 instigates a pre-integrated early warning apparatus. The initiation of this apparatus aims to pinpoint and underscore probable sectors where customers may likely encounter hindrances or perceive a diminishing quality of experience during engagements with the respective product or service.

At reference numeral 222, the system possesses the capability to interface with an analytical repository housing sets of computational instructions tailored for dissecting the friction metric. This analytical repository can encompass various algorithmic structures and methodologies designed to facilitate a comprehensive study of the friction metric. One such exemplary structure contained within the analysis database is a “decision tree.” A decision tree is a flowchart-like tree structure where an internal node represents a feature (or attribute), the branch represents a decision rule, and each leaf node represents an outcome. Utilizing such structures, the system can make determinative conclusions or predictions based on inputted data, thereby assisting in a more nuanced and detailed examination of the friction metric.

At reference numeral 224, the friction metric can be validated to verify the precision and dependability of the friction metric as a tool for improving customer experience. To authenticate the friction metric, the module contrasts it with various metrics, including Voice of the Customer (VOC) data, which aggregates customer feedback, and Customer Satisfaction (CSAT) scores, which measure customer contentment with a product or service. Additionally, the module employs Incident Management Protocols, utilizing various channels such as telephonic communication and social media monitoring, to gauge customer reactions to service incidents. The validation culminates in a correlation analysis, correlating the friction metric with these metrics to detect patterns, ensuring the score accurately reflects potential issues with the product or service based on customer feedback.

In certain embodiments, upon validation of the friction metric, the system is configured to store the resulting data in a designated storage repository. It is further contemplated that before this validated data is utilized as either control data or training data for refining the algorithm, designated as algorithm 208, a manual review process may be instituted. This manual review involves an individual or team of individuals assessing the accuracy and relevance of the data. The objective behind this review is to ensure the reliability and validity of the data before it plays a role in the modification or enhancement of the algorithm 208.

Subsequent to the validation process, the affirmed results are suitable for utilization as either control data or training data. For example, these results can be earmarked to facilitate the training of the algorithm 208, at reference numeral 228. The intent behind using this validated data is to further refine and enhance the capabilities and accuracy of the neural network algorithm 208, ensuring its proficiency in processing subsequent data sets and producing reliable outputs.

At reference number 226, the system is equipped to produce a report, with the primary objective of delivering information detailing the sequence of events that culminated in the breach of predetermined thresholds. In an illustrative embodiment, the report can identify specific probabilities or chances that pertain to possible issues, discrepancies or anomalies in the online product or service. Additionally, the report 226 is constructed to furnish a listing of various hardware entities, specifically, the types of electronic devices, utilized by the customers at the juncture wherein the identified problem or issue became evident. Such a listing aids in determining if specific hardware configurations were more susceptible to the identified problem.

The report can also categorize and profile end-user demographics predominantly affected by the identified discrepancy, which can provide nuanced insights into which specific user cohorts encountered the highest impact. Further, the report can integrate data related to user interactions, specifically transactions to delineate discernible patterns or regularities observed amongst the interactions that witnessed detrimental effects.

In certain embodiments, once the report reaches its finalized state, it is suitably disseminated to pertinent parties or specialized teams within a corporate framework. Such distribution ensures that the concerned individuals or departments are equipped with the necessary information, thereby enabling them to strategize and implement both corrective and preventive strategies in response to the insights presented in the report.

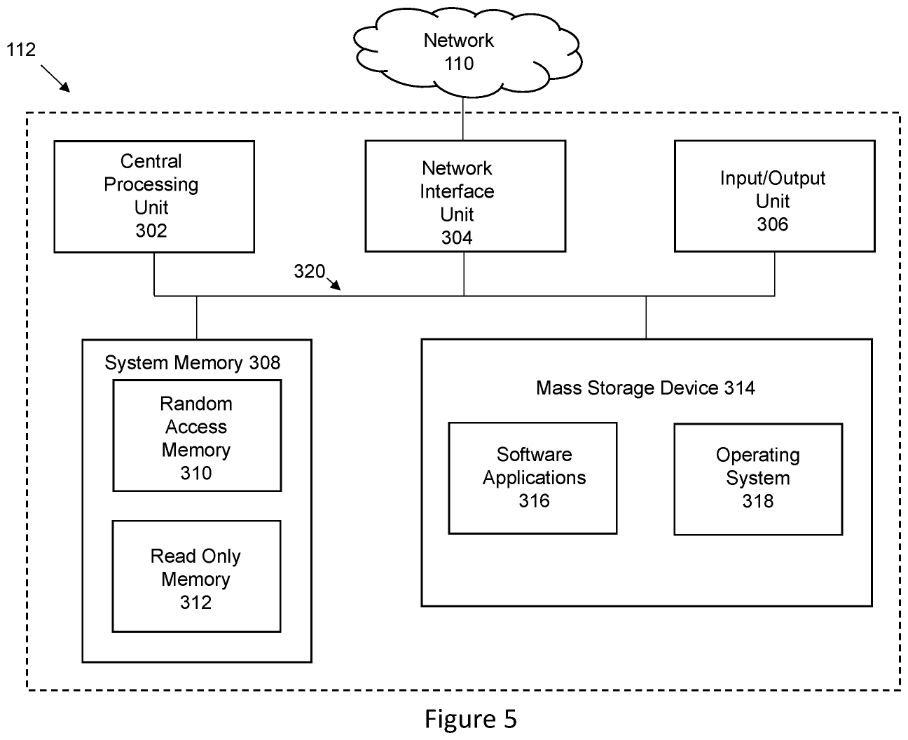

As illustrated in the embodiment of FIG. 5, the example behavioral data device 112, which provides the functionality described herein, can include at least one central processing unit (“CPU”) 302, a system memory 308, and a system bus 320 that couples the system memory 308 to the CPU 302. The system memory 308 includes a random access memory (“RAM”) 310 and a read-only memory (“ROM”) 312. A basic input/output system containing the basic routines that help transfer information between elements within the behavioral data device 112, such as during startup, is stored in the ROM 312. The data pipeline device 104 further includes a mass storage device 314. The mass storage device 314 can store software instructions and data. A central processing unit, system memory, and mass storage device similar to that shown can also be included in the other computing devices disclosed herein.

The mass storage device 314 is connected to the CPU 302 through a mass storage controller (not shown) connected to the system bus 320. The mass storage device 314 and its associated computer-readable data storage media provide non-volatile, non-transitory storage for the behavioral data device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the behavioral data analytics device 112.

According to various embodiments of the invention, the behavioral data device 112 may operate in a networked environment using logical connections to remote network devices through network 110, such as a wireless network, the Internet, or another type of network. The network 110 provides a wired and/or wireless connection. In some examples, the network 110 can be a local area network, a wide area network, the Internet, or a mixture thereof. Many different communication protocols can be used.

The behavioral data analytics device 112 may connect to network 110 through a network interface unit 304 connected to the system bus 320. It should be appreciated that the network interface unit 304 may also be utilized to connect to other types of networks and remote computing systems. The behavioral data analytics device 112 also includes an input/output controller 306 for receiving and processing input from a number of other devices, including a touch user interface display screen or another type of input device. Similarly, the input/output controller 306 may provide output to a touch user interface display screen or other output devices.

As mentioned briefly above, the mass storage device 314 and the RAM 310 of the behavioral data device 112 can store software instructions and data. The software instructions include an operating system 318 suitable for controlling the operation of the behavioral data device 112. The mass storage device 314 and/or the RAM 310 also store software instructions and applications 316, that when executed by the CPU 302, cause the behavioral data device 112 to provide the functionality of the behavioral data analytics device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for assessing customer friction during interactions with a product or service, the method comprising:
accessing behavioral data sources, including: (i) a first source capturing event-level data marking customer interactions within the product or service; (ii) a second source recording user session replays that offer a granular visualization of user behavior; and (iii) a third source providing application performance monitoring;
calculating a friction metric by: (i) analyzing data extracted from the behavioral data sources; (ii) assigning weighted values to at least one of events, user behaviors, or performance indicators based on a correlation with an increase in the customer friction; and (iii) updating the friction metric to capture real-time changes in customer behavior as a customer engages with the product or service; and
launching a root cause analysis when the friction metric surpasses a threshold.

2. The method of claim 1, wherein the first behavioral data source is primarily with capturing event-level data that highlights customer interactions within the product or service.

3. The method of claim 1, wherein the second behavioral data source is designed to document user session replays, offering a detailed perspective on user behavior.

4. The method of claim 1, wherein the third behavioral data source is adapted to provide application performance insights, including systemic or infrastructure-level information.

5. The method of claim 1, wherein the root cause analysis further identifies potential complications or areas of dissatisfaction experienced by customers during their interactions with the product or service.

6. The method of claim 1, further comprising generating a comprehensive report upon detection of elevated friction, the report detailing at least one of:
(i) a specific nature or type of error or issue;
(ii) devices on which the product or service was accessed or utilized;
(iii) identities or characteristics of affected customers; and
(iv) pertinent transaction information related to the interactions,
wherein the comprehensive report is communicated to a response team for review.

7. The method of claim 1, wherein the validity of the derived friction metric is confirmed by at least one of:
(i) juxtaposing the friction metric with customer survey and feedback data from customers;
(ii) correlating the friction metric with customer satisfaction scores; or
(iii) drawing parallels through a comparative evaluation with incident management protocols, including monitoring of telephonic activity and assessments of social media interactions.

8. A computer system for assessing customer friction during interactions with a product or service, comprising:
one or more processors; and
non-transitory computer readable storage media encoding instructions which, when executed by the one or more processors, causes the computer system to:
access three distinct behavioral data sources, including: (i) a first source, tasked to capture event-level data marking customer interactions within the product or service; (ii) a second source, designed to record user session replays, offering a granular visualization of user behavior; and (iii) a third source, formulated to provide application performance monitoring with an emphasis on system-level insights;
calculate a friction metric by: (i) analyzing and combining data extracted from the three distinct behavioral data sources, the data representing events, user behaviors, or performance indicators; (ii) assigning weighted values to at least one of events, user behaviors, or performance indicators based on a correlation with an increase in customer friction; and (iii) updating the calculated friction metric to capture real-time changes in customer behavior as they engage with the product or service; and
launch a root cause analysis when the friction metric surpasses one or more predefined thresholds, with the analysis aiming to identify specific elements causing the observed customer friction and enabling directed improvements.

9. The computer system of claim 8, wherein the first behavioral data source is configured to capture event-level data reflecting customer interactions within the product or service.

10. The computer system of claim 8, wherein the second behavioral data source is purposed to document user session replays, thereby offering an intricate view of user activity.

11. The computer system of claim 8, wherein the third behavioral data source is structured to furnish application performance metrics, encompassing systemic or infrastructure-related data.

12. The computer system of claim 8, wherein the root cause analysis additionally discerns probable complications or areas of dissatisfaction customers might confront during their engagements with the product or service.

13. The computer system of claim 8, further capable of composing an exhaustive report when heightened friction is detected, the report elucidating at least one of:
(i) the particular type or nature of the detected issue;
(ii) the devices on which the product or service was accessed;
(iii) attributes or profiles of the impacted customers; and
(iv) relevant transactional data tied to those interactions,
with the intent that the comprehensive report is relayed to a designated team for assessment.

14. The computer system of claim 8, wherein the validity of the derived friction metric is verified by at least one of:
(i) comparing the friction metric with customer survey and feedback data;
(ii) correlating the friction metric with customer satisfaction metrics; or
(iii) conducting a comparative evaluation with incident management protocols, which encompasses monitoring of telephonic activity and analyses of social media feedback.

15. A computer program product residing on a non-transitory computer readable storage medium having a plurality of instructions stored thereon, which when executed by a processor, cause the processor to perform operations for assessing customer friction during interactions with a product or service, comprising:
accessing three distinct behavioral data sources, including: (i) a first source, tasked to capture event-level data marking customer interactions within the product or service; (ii) a second source, designed to record user session replays, offering a granular visualization of user behavior; and (iii) a third source, formulated to provide application performance monitoring with an emphasis on system-level insights;
calculating a friction metric by: (i) analyzing and combining data extracted from the three distinct behavioral data sources, the data representing events, user behaviors, or performance indicators; (ii) assigning weighted values to at least one of events, user behaviors, or performance indicators based on a correlation with an increase in customer friction; and (iii) updating the calculated friction metric to capture real-time changes in customer behavior as they engage with the product or service; and
launching a root cause analysis when the friction metric surpasses one or more predefined thresholds, with the analysis aiming to identify specific elements causing the observed customer friction and enabling directed improvements.

16. The computer program product of claim 15, wherein validation of the derived friction metric involves at least one of:
(i) comparison of the friction metric with customer survey and feedback data;
(ii) correlation of the friction metric with metrics of customer satisfaction; or
(iii) evaluation in line with incident management procedures, which include surveillance of telephonic communications and analysis of social media interactions.

17. The computer program product of claim 15, wherein the first behavioral data source is configured primarily to capture event-level data that detail interactions of customers within the product or service.

18. The computer program product of claim 15, wherein the second behavioral data source is set to chronicle replays of user sessions, offering a detailed viewpoint on user dynamics.

19. The computer program product of claim 15, wherein the third behavioral data source delivers metrics related to application performance, with data that covers both system and infrastructure aspects.

20. The computer program product of claim 15, wherein the root cause analysis further discerns potential challenges or areas where customers experience dissatisfaction during their usage of the product or service.
